(19) United States
(12) Patent Application Publication
(10) Pub. No.: US 2020/0378393 A1
(43) Pub. Date: Dec. 3, 2020

(54) COMBINED CEILING FAN AND LIGHT FIXTURE

(71) Applicant: Zhiping Zhou, Alhambra, CA (US)

(72) Inventor: Zhiping Zhou, Alhambra, CA (US)

(21) Appl. No.: 16/430,046

(22) Filed: Jun. 3, 2019

(51) Int. Cl. F04D 25/08; F04D 29/00; F04D 29/053; F04D 29/32; F21V 33/00; F21S 8/04

(52) U.S. Cl. CPC F04D 25/088; F04D 29/005; F21S 8/043; F04D 29/322; F21V 33/0096; F04D 29/053

(57) ABSTRACT

The invention relates to a combined ceiling fan and light fixture, wherein the roots of the plurality of blades of the ceiling fan are respectively fixedly connected to a plurality of rotating components correspondingly arranged on the impeller. Each rotating component comprises a synchronous wheel, and all synchronous wheels are distributed on the bottom of the impeller with the wheel center of the impeller as the array center. Any two adjacent synchronous wheels are connected to each other by a swinging rod so that all the synchronous wheels move in the same direction with the corresponding blades. At least one swinging rod is connected with a spring for pulling the swinging rod back in the opposite direction of the centrifugal force of the blade to drive all the blades to be synchronously folded on the top of the impeller when the motor stops. The blade retraction mechanism of the invention has the advantages of high transmission precision, good operational stability, low noise and low cost.

### TECHNICAL FIELD

The invention described herein relates to a combined ceiling fan and light fixture. More particularly the invention relates to a blade retraction mechanism of a combined ceiling fan and light fixture.

### BACKGROUND

Patent No. 200680032396.1 discloses a combined ceiling fan and light fixture in which individual fan blades are connected by a transmission consisting of sun and planet gears to be synchronously expanded in working condition and retracted in folded position. The gear transmission has the disadvantages of poor transmission precision and operation stability, loud noise and high material cost.

### SUMMARY

The present invention discloses a combined ceiling fan and light fixture intended to improve the aforementioned drawbacks of the blade connection of the patent.

The present invention adopts the following technical solutions for the purpose:

A combined ceiling fan and light fixture comprising of a boom, a motor located at the bottom of the boom, and an impeller and a lamp holder located at the bottom of the motor. The impeller is fixedly connected with the rotor of the motor to be driven by the motor to rotate. The lamp holder is arranged under the impeller and fixedly connected to the stator of the motor, a lamp is fixedly mounted on the bottom surface thereof. The top surface of the impeller is provided with a plurality of blades, and the roots of blades are respectively fixedly connected to the corresponding sets of rotating components on the impeller, so as to be when the motor is working, the impeller rotates and expands into a working condition under the action of centrifugal force. Each rotating component comprises a synchronous wheel, and all synchronous wheels are distributed on the bottom of the impeller with the wheel center of the impeller as the array center. Any two adjacent synchronous wheels are connected to each other by a swinging rod so that all the synchronous wheels move in the same direction with the corresponding blades. At least one swinging rod is connected with a spring for pulling the swinging rod back in the opposite direction of the centrifugal force of the blade to drive all the blades to be synchronously folded on the top of the impeller when the motor stops.

As a further improvement of the above solution, each of the synchronous wheels has two convex axial faces spaced apart from each other, and each of the convex axial faces is vertically provided with an internal threaded shaft.

The two ends of each swinging rod are movably sleeved on the two adjacent synchronous wheels close to the internal threaded shaft by the long shaft holes at the respective ends, so that the plurality of swinging rods are head-to-tail connected to the plurality of synchronous wheels to form a synchronous co-directional moving body, with having the folding position and the unfolding position of the plurality of blades respectively limited to the two ends of the long shaft holes.

As a further improvement of the above solution, the middle part of each swinging rod is rotatably connected to the impeller by a set of swinging shaft module.

The swinging shaft module includes a rod base, a fixing base, a screw bolt and a screw nut. The fixing base and the rod base are respectively disposed on the top and bottom of the impeller, and the two are vertically opposed to each other through a through-hole on the impeller. The fixing base is fixed on the impeller, and the swinging rod is connected on the rod base. The bolt passes through the center hole of the swinging rod, the rod base and the fixing base and is screwed to the nut. When the swinging rod is fixed to the rod base, the swinging rod and the rod base are rotatably connected to the fixing base by using the bolt as a shaft.

As a further improvement of the above solution, the bottom surface of the rod base is provided with spherical bumps for reducing friction between it and the top surface of the impeller.

As a further improvement of the above solution, the middle part of the swinging rod is connected to the slot on the bottom of the rod base.

As a further improvement of the above solution, the swinging rod is connected to the positioning piece on the bottom of the rod base through the long positioning hole of the rod center.

As a further improvement of the above solution, the fixing base is fixed to the impeller through connecting the cylindric joint and the curved joint piece of the fixing base and the circular joint hole and the arc joint hole of the impeller.

As a further improvement of the above solution, the springs on the swinging rod are disposed in pairs, and each pair of springs is equally and symmetrically disposed at two ends of the swinging rod. The swinging rod is pulled together by a pull-in and pull-out method to balance the two ends of the swinging rod.

As a further improvement of the above solution, one end of the spring is connected to the first spring button on the bottom of the impeller, and the other end is connected to the second spring button on the swinging rod.

Different from the comparative patent, the present invention connects the blades of the combined ceiling fan and light fixture by means of the synchronous wheel, the swinging rod and the spring. The mechanism of swinging rod and synchronous wheel has the advantages of high transmission precision, good operational stability, low noise and low cost.

### BRIEF DESCRIPTION OF DRAWINGS

FIG. 1 is an overall structural view according to an embodiment of the present invention;

FIG. 2 is a structural view of blade mechanism according to an embodiment of the present invention;

FIG. 3 is a mounting structural view of swinging shaft module according to an embodiment of the present invention;

FIG. 4 is a structural view of synchronous wheel according to an embodiment of the present invention;

FIG. 5 is a structural view of swinging rod according to an embodiment of the present invention;

FIG. 6 is a structural view of rod base according to an embodiment of the present invention;

FIG. 7 is a structural view of fixing base according to an embodiment of the present invention;

FIG. 8 is a structural view of the bottom surface of impeller according to an embodiment of the present invention.

### DESCRIPTION OF EMBODIMENTS

The invention is described with reference to the drawings and specific embodiments.

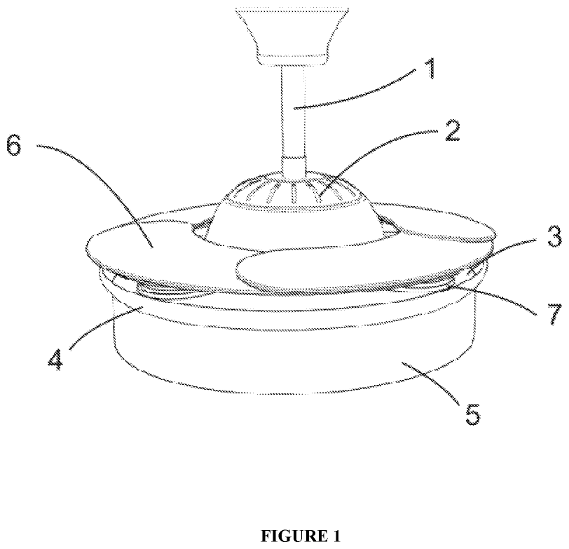

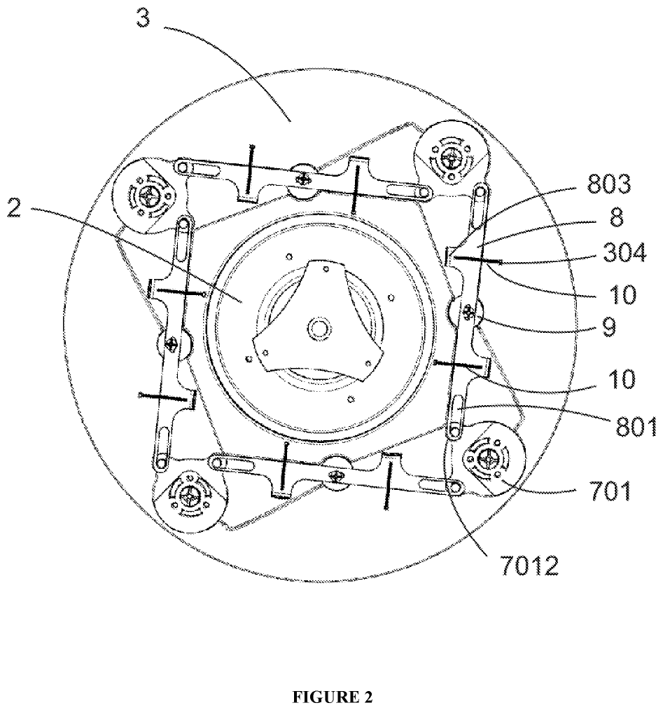

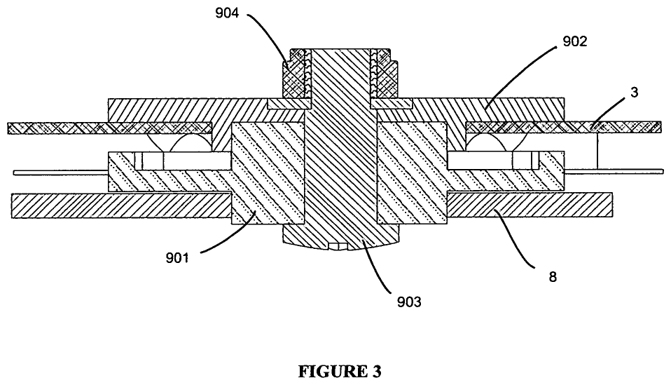

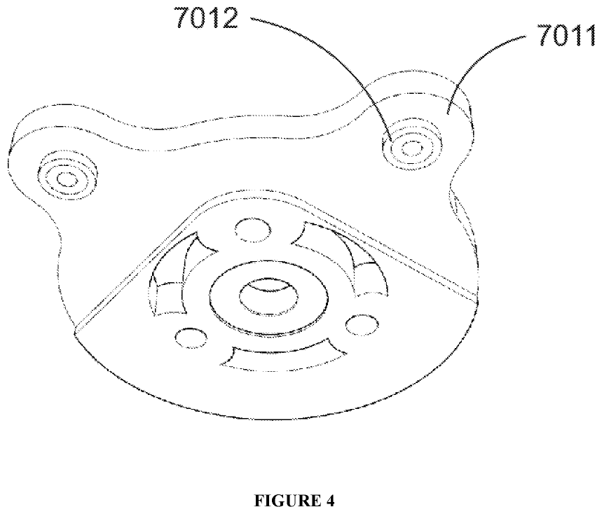

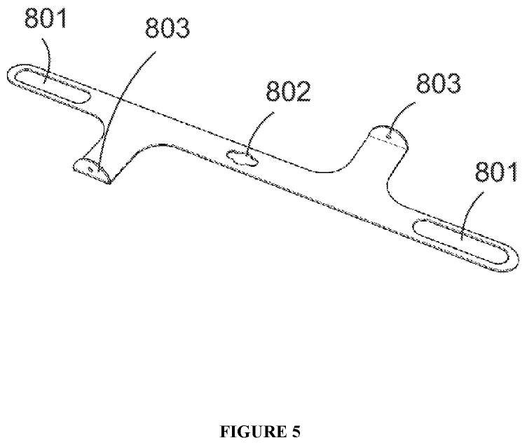

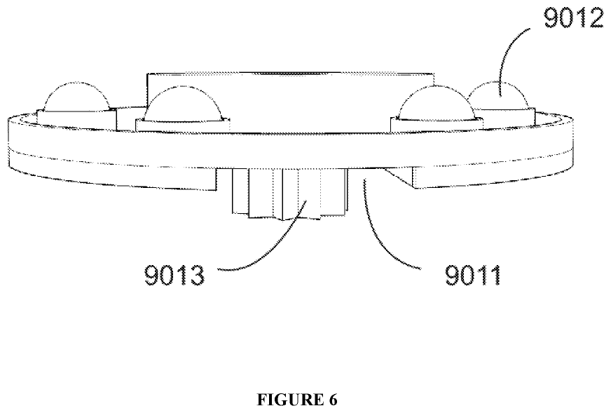

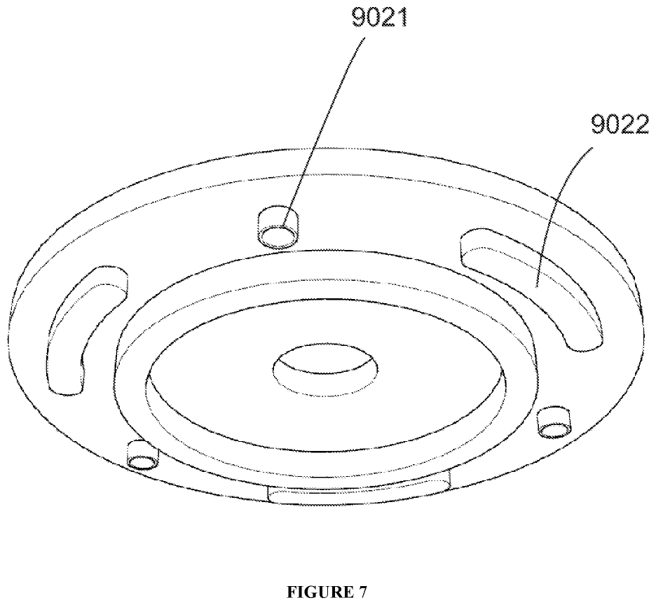

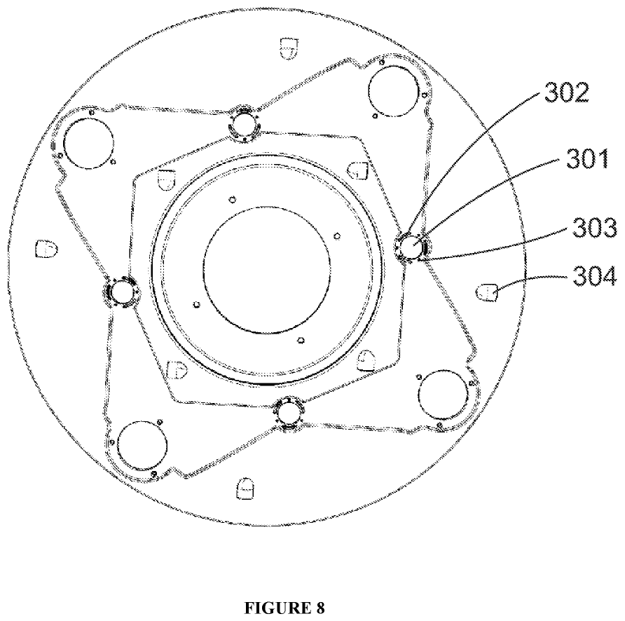

Referring to FIGS. 1-8:

A combined ceiling fan and light fixture comprising of a boom 1, a motor 2 located at the bottom of the boom 1, and an impeller 3 and a lamp holder 4 located at the bottom of the motor 2. The impeller 3 is fixedly connected with the rotor of the motor 2 to be driven by the motor 2 to rotate. The lamp holder 4 is arranged under the impeller 3 and fixedly connected to the stator of the motor 2, a lamp 5 is fixedly mounted on the bottom surface thereof. The top surface of the impeller 3 is provided with a plurality of blades 6, and the roots of blades 6 are respectively fixedly connected to the corresponding sets of rotating components 7 on the impeller 3, so as to be when the motor 2 is working, the impeller 3 rotates and expands into a working condition under the action of centrifugal force.

Each rotating component 7 comprises a synchronous wheel 701, and all synchronous wheels 701 are distributed on the bottom of the impeller 3 with the wheel center of the impeller 3 as the array center. Any two adjacent synchronous wheels 701 are connected to each other by a swinging rod 8 so that all the synchronous wheels 701 move in the same direction with the corresponding blades 6.

Each swinging rod 8 is connected with a spring 10 for pulling the swinging rod 8 back in the opposite direction of the centrifugal force of the blade 6 to drive all the blades 6 to be synchronously folded on the top of the impeller 3 when the motor 2 stops. Each pair of springs 10 is equally and symmetrically disposed at two ends of the swinging rod 8. One end of the spring 10 is connected to the first spring button 304 on the bottom of the impeller 3, and the other end is connected to the second spring button 803 on the swinging rod 8. The swinging rod 8 is pulled together by a pull-in and pull-out method to balance the two ends of the swinging rod 8.

Each of the synchronous wheels 701 has two convex axial faces 7011 spaced apart from each other, and each of the convex axial faces 7011 is vertically provided with an internal threaded shaft 7012.

The two ends of each swinging rod 8 are movably sleeved on the two adjacent synchronous wheels 701 close to the internal threaded shaft 7012 by the shaft holes 801 at the respective ends, so that the plurality of swinging rods 8 are head-to-tail connected to the plurality of synchronous wheels 701 to form a synchronous co-directional moving body, with having the folding position and the unfolding position of the plurality of blades 6 respectively limited to the two ends of the long shaft holes 801.

The middle part of each swinging rod 8 is rotatably connected to the impeller 3 by a set of swinging shaft module 9. The swinging shaft module 9 includes a rod base 901, a fixing base 902, a screw bolt 903 and a screw nut 904. The fixing base 902 and the rod base 901 are respectively disposed on the top and bottom of the impeller 3, and the two are vertically opposed to each other through a through-hole 301 on the impeller 3. The fixing base 902 is fixed on the impeller 3, and the swinging rod 8 is connected on the rod base 901. The bolt 903 passes through the center hole of the swinging rod 8, the rod base 901 and the fixing base 902 and is screwed to the nut 904. When the swinging rod 8 is fixed to the rod base 901, the swinging rod 8 and the rod base 901 are rotatably connected to the fixing base 902 by using the bolt 903 as a shaft, so that the swinging rod 8 and the rod base 901 become a synchronous rotating body associated with the blades 6.

The bottom surface of the rod base 901 is provided with spherical bumps 9012 for reducing friction between it and the top surface of the impeller 3.

The middle part of the swinging rod 8 is connected to the slot 9011 on the bottom of the rod base 901.

The swinging rod 8 is connected to the positioning piece 9013 on the bottom of the rod base 901 through the long positioning hole 802 of the rod center.

The fixing base 902 is fixed to the impeller 3 through connecting the cylindric joint 9021 and the curved joint piece 9022 of the fixing base 902 and the circular joint hole 302 and the arc joint hole 303 of the impeller 3.

The working principle of the invention is: when the motor 2 is working, the impeller 3 is driven to rotate, and all the blades 6 on the top of the impeller 3 rotate with the impeller 3. As the rotation speed gradually accelerate, the centrifugal force obtained by each blade 6 is gradually increased. When the centrifugal force on each blade 6 is greater than the sum of the tensile strength of all the springs 10, all of the springs 10 are elongated until the blades 6 are fully deployed outwardly in the working condition. When the motor 2 stops, the rotation speed of each blade 6 is gradually reduced, and the centrifugal force is gradually decreased. When the sum of the centrifugal force on each blade 6 is less than the sum of the tensile strength of all the springs 10, each blade 6 is drawn inward by the corresponding spring 10 until it is completely folded onto the top of the impeller 3 in a resting mode.

The invention claimed is:

1. A combined ceiling fan and light fixture comprising of a boom (1), a motor (2) located at the bottom of the boom (1), and an impeller (3) and a lamp holder (4) located at the bottom of the motor (2). The impeller (3) is fixedly connected with the rotor of the motor (2) to be driven by the motor (2) to rotate. The lamp holder (4) is arranged under the impeller (3) and fixedly connected to the stator of the motor (2), a lamp (5) is fixedly mounted on the bottom surface thereof. The top surface of the impeller (3) is provided with a plurality of blades (6), and the roots of blades (6) are respectively fixedly connected to the corresponding sets of rotating components (7) on the impeller (3), so as to be when the motor (2) is working, the impeller (3) rotates and expands into a working condition under the action of centrifugal force. The characteristic is that each rotating component (7) comprises a synchronous wheel (701), and all synchronous wheels (701) are distributed on the bottom of the impeller (3) with the wheel center of the impeller (3) as the array center. Any two adjacent synchronous wheels (701) are connected to each other by a swinging rod (8) so that all the synchronous wheels (701) move in the same direction with the corresponding blades (6). At least one swinging rod (8) is connected with a spring (10) for pulling the swinging rod (8) back in the opposite direction of the centrifugal force of the blade (6) to drive all the blades (6) to be synchronously folded on the top of the impeller (3) when the motor (2) stops.

2. A combined ceiling fan and light fixture according to claim 1 wherein each of the synchronous wheels (701) has two convex axial faces (7011) spaced apart from each other, and each of the convex axial faces (7011) is vertically provided with an internal threaded shaft (7012). The two ends of each swinging rod (8) are movably sleeved on the two adjacent synchronous wheels (701) close to the internal threaded shaft (7012) by the long shaft holes (801) at the respective ends, so that the plurality of swinging rods (8) are head-to-tail connected to the plurality of synchronous wheels (701) to form a synchronous co-directional moving body, with having the folding position and the unfolding position of the plurality of blades (6) respectively limited to the two ends of the long shaft holes (801).

3. A combined ceiling fan and light fixture according to claim 1 wherein the middle part of each swinging rod (8) is rotatably connected to the impeller (3) by a set of swinging shaft module (9). The swinging shaft module (9) includes a rod base (901), a fixing base (902), a screw bolt (903) and a screw nut (904). The fixing base (902) and the rod base (901) are respectively disposed on the top and bottom of the impeller (3), and the two are vertically opposed to each other through a through-hole (301) on the impeller (3). The fixing base (902) is fixed on the impeller (3), and the swinging rod (8) is connected on the rod base (901). The bolt (903) passes through the center hole of the swinging rod (8), the rod base (901) and the fixing base (902) and is screwed to the nut (904). When the swinging rod (8) is fixed to the rod base (901), the swinging rod (8) and the rod base (901) are rotatably connected to the fixing base (902) by using the bolt (903) as a shaft.

4. A combined ceiling fan and light fixture according to claim 3 wherein the bottom surface of the rod base (901) is provided with spherical bumps for reducing friction between it and the top surface of the impeller (3).

5. A combined ceiling fan and light fixture according to claim 3 wherein the middle part of the swinging rod (8) is connected to the slot (9011) on the bottom of the rod base (901).

6. A combined ceiling fan and light fixture according to claim 3 wherein the swinging rod (8) is connected to the positioning piece (9013) on the bottom of the rod base (901) through the long positioning hole (802) of the rod center.

7. A combined ceiling fan and light fixture according to claim 3 wherein the fixing base (902) is fixed to the impeller (3) through connecting the cylindric joint (9021) and the curved joint piece (9022) of the fixing base (902) and the circular joint hole (302) and the arc joint hole (303) of the impeller (3).

8. A combined ceiling fan and light fixture according to claim 1 wherein the springs (10) on the swinging rod (8) are disposed in pairs, and each pair of springs (10) is equally and symmetrically disposed at two ends of the swinging rod (8). The swinging rod (8) is pulled together by a pull-in and pull-out method to balance the two ends of the swinging rod (8).

9. A combined ceiling fan and light fixture according to claim 1 wherein one end of the spring (10) is connected to the first spring button (304) on the bottom of the impeller (3), and the other end is connected to the second spring button (803) on the swinging rod (8).
